(19) United States
(12) Patent Application Publication
(10) Pub. No.: US 2024/0176740 A1
(43) Pub. Date: May 30, 2024

(54) HOST MANAGED MEMORY SHARED BY MULTIPLE HOST SYSTEMS IN A HIGH AVAILABILITY SYSTEM

(71) Applicant: Intel Corporation, Santa Clara, CA (US)

(72) Inventors: Krishna Kumar SIMMADHARI RAMADASS, Bangalore (IN); Rajesh BANGINWAR, Bangalore (IN)

(21) Appl. No.: 18/071,923

(22) Filed: Nov. 30, 2022

(51) Int. Cl. G06F 12/0817; G06F 12/0877; G06F 13/28

(52) U.S. Cl. CPC G06F 12/0828; G06F 12/0877; G06F 13/28

(57) ABSTRACT

A high availability system including multiple host systems includes a host managed device memory that is shared between the multiple host systems allowing faster communication between the host systems. Access to the host managed device memory in a memory expander card is via direct memory access from the host system. Memory expander card control circuitry in the memory expander card performs memory translation, gatekeeping and synchronization. A host system can access the host managed device memory in the memory expander card directly using cxl.cache and cxl.mem protocols. From the host system perspective, the host managed device memory in the memory expander card is directly attached using a memory mapped interface.

### FIELD

This disclosure relates to high availability systems and in particular to a high availability system including multiple host systems and a host managed memory that is shared between the multiple host systems.

### BACKGROUND

A high availability system typically has two host servers, a primary host server providing data and a secondary host server in standby mode to takeover when the primary host server fails. Redundancy related data used by the secondary host server when the primary host server fails is synchronized between the primary host server and the secondary host server using side band protocols, for example, InfiniBand or high speed Ethernet or via Remote Direct Memory Access (RDMA) in which the primary host server and the secondary host server have to create and process data transferred between the primary host server and the secondary host servers. Side band protocols and RDMA use multiple CPU, memory and network cycles.

### BRIEF DESCRIPTION OF THE DRAWINGS

Features of embodiments of the claimed subject matter will become apparent as the following detailed description proceeds, and upon reference to the drawings, in which like numerals depict like parts, and in which:

FIG. 1 is a block diagram illustrating a high availability system including host systems connected to a memory accelerator card that includes a host device memory shared by the host systems;

FIG. 2 is a block diagram illustrating an embodiment of the memory expander card in the high availability system shown in FIG. 1.

FIG. 3 is a block diagram illustrating coherent memory sharing between the host systems in the host managed device memory in the memory expander card in the high availability system shown in FIG. 1;

FIG. 4 is a block diagram illustrating sharing of the host device memory in the memory expander card with two host systems independently accessing different areas of the host managed device memory in the high availability system shown in FIG. 1;

FIG. 5 is a flow graph illustrating a method for performing coherent memory sharing between the host systems in the host managed device memory in the memory expander card shown in FIG. 3; and

FIG. 6 is a flow graph illustrating a method for sharing of the host device memory in the memory expander card with two host systems independently accessing different areas of the host managed device memory in the memory expander card shown in FIG. 4.

Although the following Detailed Description will proceed with reference being made to illustrative embodiments of the claimed subject matter, many alternatives, modifications, and variations thereof will be apparent to those skilled in the art. Accordingly, it is intended that the claimed subject matter be viewed broadly, and be defined as set forth in the accompanying claims.

### DESCRIPTION OF EMBODIMENTS

Compute Express Link™ (CXL™) is an industry-supported Cache-Coherent Interconnect for Processors, Memory Expansion and Accelerators. CXL technology maintains memory coherency between CPU memory space and memory on attached devices, which allows resource sharing for higher performance, reduced software stack complexity, and lower overall system cost.

A memory expander card allows host managed device memory to be shared between multiple host systems. The memory expander card can be a Type 3 CXL device. The memory accelerator card provides CXL.mem and CXL.cache access to a host managed device memory in the memory expander card. The host managed device memory on the memory expander card can be connected to multiple host systems with sufficient gatekeeping so that the multiple host systems can access the host managed memory in the memory accelerator card.

The host managed device memory in the memory expander card is shared between the multiple host systems allowing the host systems to communicate with each other faster and easier. Access to the host managed device memory in the memory expander card is via direct memory access from the host system. A Field Programmable Gate Array (FPGA) in the memory expander card performs memory translation, gatekeeping and synchronization.

A host system can access the host managed device memory in the memory expander directly using cxl.cache and cxl.mem protocols. From the host system perspective, the host managed device memory in the memory expander card is directly attached using a memory mapped interface. The cxl.cache provides a cached interface to the host managed device memory thereby speeding up access to the host managed device memory used by the multiple host systems. The gatekeeping and synchronization is performed by the cxl.cache protocol and the FPGA.

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

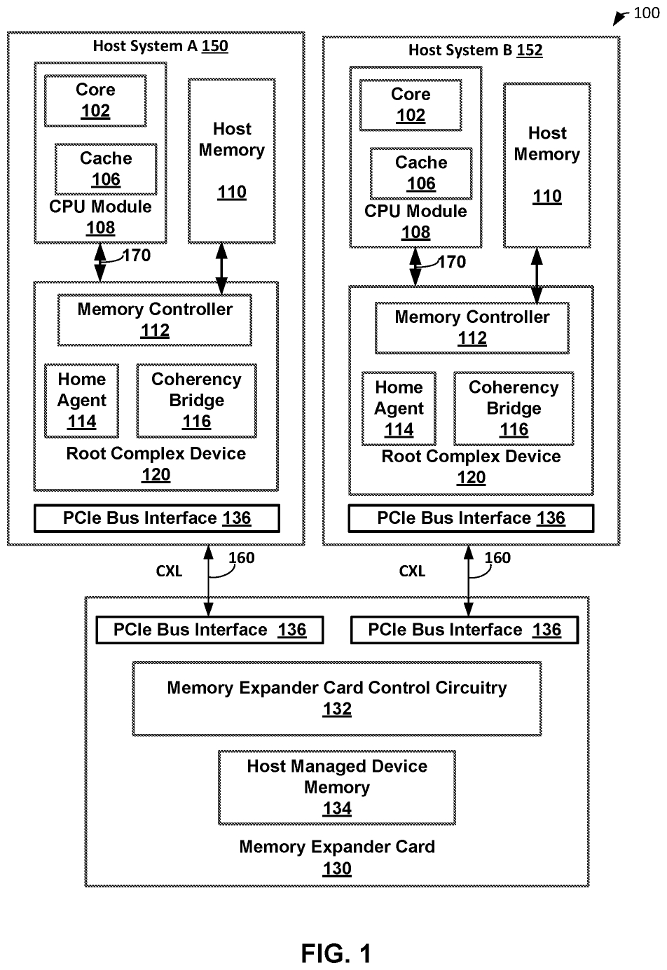

FIG. 1 is a block diagram illustrating a high availability system 100 including host systems 150, 152 connected to a memory expander card 130 that includes a host managed device memory 134 shared by the host systems 150, 152.

The high availability system includes host system A 150 and host system B 152. In an embodiment, host system A 150 can be a primary host system and host system B 152 can be a secondary host system.

Each host system 150 includes a CPU module 108, a host memory 110 and a root complex device 120. The CPU module 108 includes at least one processor core 102, and a level 2 (L2) cache 106. Although not shown, each of the processor core(s) 102 can internally include one or more instruction/data caches, execution units, prefetch buffers, instruction queues, branch address calculation units, instruction decoders, floating point units, retirement units, etc. The CPU module 108 can correspond to a single core or a multi-core general purpose processor, such as those provided by Intel® Corporation, according to one embodiment.

The host memory 110 can be a volatile memory. Volatile memory is memory whose state (and therefore the data stored on it) is indeterminate if power is interrupted to the device. Nonvolatile memory refers to memory whose state is determinate even if power is interrupted to the device. Dynamic volatile memory requires refreshing the data stored in the device to maintain state. One example of dynamic volatile memory includes DRAM (dynamic random access memory), or some variant such as synchronous DRAM (SDRAM). A memory subsystem as described herein may be compatible with a number of memory technologies, such as DDR3 (double data rate version 3, original release by JEDEC (Joint Electronic Device Engineering Council) on Jun. 27, 2007, currently on release 21), DDR4 (DDR version 4, JESD79-4 initial specification published in September 2012 by JEDEC), DDR4E (DDR version 4, extended, currently in discussion by JEDEC), LPDDR3 (low power DDR version 3, JESD209-3B, August 2013 by JEDEC), LPDDR4 (LOW POWER DOUBLE DATA RATE (LPDDR) version 4, JESD209-4, originally published by JEDEC in August 2014), WIO2 (Wide I/O 2 (WideIO2), JESD229-2, originally published by JEDEC in August 2014), HBM (HIGH BANDWIDTH MEMORY DRAM, JESD235, originally published by JEDEC in October 2013), DDR5 (DDR version 5, currently in discussion by JEDEC), LPDDR5, originally published by JEDEC in January 2020, HBM2 (HBM version 2), originally published by JEDEC in January 2020, or others or combinations of memory technologies, and technologies based on derivatives or extensions of such specifications. The JEDEC standards are available at www.jedec.org.

A root complex device 120 connects the CPU Module 108 and the host memory 110 to a Peripheral Component Interconnect Express (PCIe) switch fabric composed of one or more PCIe or PCI devices. The root complex device 120 generates transaction requests on behalf of the CPU Module 108. CXL is built on the PCIe physical and electrical interface and includes PCIe-based block input/output protocol (CXL.io) and cache-coherent protocols for accessing system memory (CXL.cache) and device memory (CXL.mem).

The root complex device 120 includes a memory controller 112, a home agent 114 and a coherency bridge 116. The memory controller 112 manages read and write of data to and from host memory 110. The home agent 114 orchestrates cache coherency and resolves conflicts across multiple caching agents, for example, CXL devices, local cores and other CPU modules. The home agent 114 includes a caching agent and implements a set of caching commands, for example, requests and snoops.

The coherency bridge 116 manages coherent accesses to the system interconnect 170. The coherency bridge 116 prefetches coherent permissions for requests from a coherency directory so that it can execute these requests concurrently with non-coherent requests and maintain high bandwidth on the system interconnect 170.

The memory expander card 130 includes memory expander card control circuitry 132 and host managed device memory 134. The host managed device memory 134 can be accessed by the host systems 150, 152 directly similar to a memory mapped device. The host system A 150 and the host system B 152 includes a PCIe bus interface 136. The memory expander card 130 includes a PCIe bus interface 136. The host systems 150, 152 and the memory expander card 130 communicate via the PCIe bus interface 136 over a communications bus, PCIe bus 160. The host systems 150, 152 access the memory expander card 130 via the PCIe bus interface using the CXL protocol (CXL.mem and CXL.cache) over the PCIe bus 160.

The memory expander card control circuitry 132 provides read and write access to the host managed device memory 134 in response to read and write requests sent by the host systems 150, 152 using the CXL protocol over PCIe bus 160. The memory expander card control circuitry 132 provides gate keeping and synchronization to ensure memory coherency for the host managed device memory 134 that is shared by both host system A 150 and host system B 152.

A write operation to the host managed device memory 134 from the host system point of view is similar to a write operation to host memory 110. The host CPU performs a cache snoop for the memory write transaction to check for a cache hit. If there is a cache miss, the home agent 114 sends a memory read transaction to the host managed device memory 134 to read the data. The home agent 114 also populates other caches with the data read from the host managed device memory 134 for faster read access to the data.

The host managed device memory 134 can be a non-volatile memory to ensure availability of storage logs in the event of a catastrophic power loss. A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also include a byte-addressable write-in-place three dimensional cross-point memory device, or other byte addressable write-in-place NVM devices (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

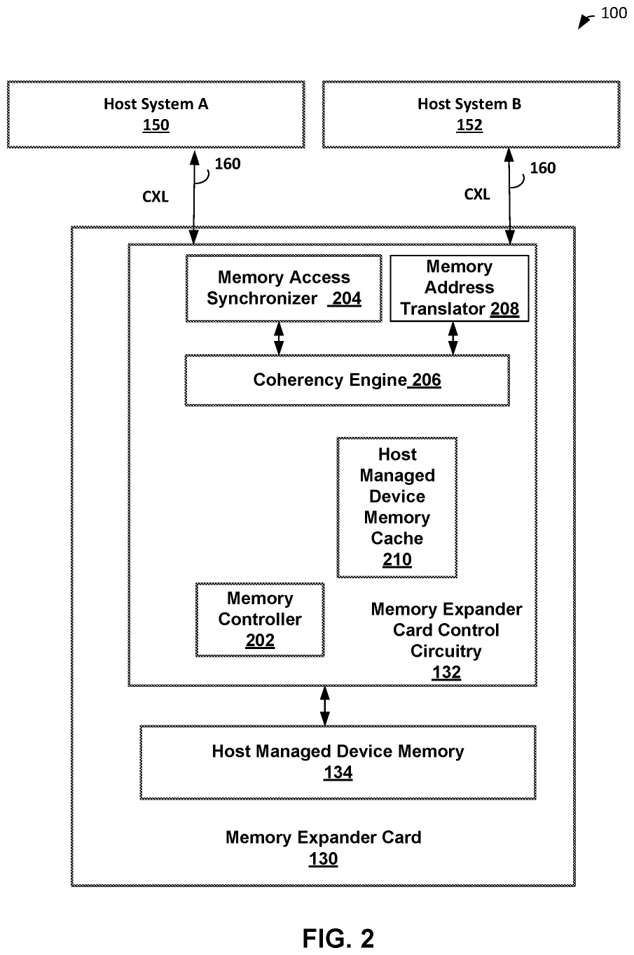

FIG. 2 is a block diagram illustrating an embodiment of the memory expander card 130 in the high availability system 100 shown in FIG. 1. The memory expander card control circuitry 132 includes a memory access synchronizer 204, a memory address translator 208, a coherency engine 206, a host managed device memory cache 210 and a memory controller 202.

The memory access synchronizer 204 synchronizes concurrent accesses by the host system A 150 and the host system B 152 to the same memory addresses in the host managed device memory 134. The memory address translator 208 translates received virtual memory addresses to physical addresses in the host managed device memory 134.

The coherency engine 206 maintains cache coherency between the CPU cache (for example, level 2 (L2) cache 106) and the host managed device memory cache 210. The host managed device memory cache 210 caches memory requests received from the host system A 150 or host system B 152 for host managed device memory 134. The memory controller 202 manages read and write of data to and from host managed device memory 134.

The memory expander card control circuitry 132 acts as the gatekeeper for access to the host managed device memory 134 to allow host system A 150 and host system B 152 to communicate with each other via the host managed device memory 134. In an embodiment, the memory expander card control circuitry 132 is a Field Programmable Gate Array (FPGA). In another embodiment, the memory expander card control circuitry 132 is an Application Specific Integrated Circuit (ASIC).

Both host system A 150 and host system B 152 independently map the host managed device memory 134 into their respective memory address space. Access by host system A 150 and host system B 152 to the host managed device memory 134 is managed by the memory access synchronizer 204 and the memory address translator 208 to ensure that only one host system (for example, host system A 150 or host system B 152) can access the host managed device memory 134 at one time. The memory access synchronizer 204 also ensures that the accesses to the host managed device memory 134 are serial, for example, if host system A 150 and host system B 152 try to access the host managed device memory 134 at the same time, the requests are sent serially one at a time to the host managed device memory 134.

The memory expander card control circuitry 132 services host initiated read requests and host initiated write requests received from host system A 150 and host system B 152 using the CXL protocol over the PCIe bus 160. A received host initiated read request is directed by the memory address translator 208 to the coherency engine 206. The coherency engine 206 maintains coherency between data in the host managed device memory cache 210 and data in the host managed device memory 134.

The received host initiated read request is sent to the host managed device memory cache 210 to provide cached read data stored in the host managed device memory cache 210 to the host system that initiated the read request. Multiple host initiated write requests are synchronized by the memory access synchronizer 204 to ensure that data written to the host managed device memory 134 is written correctly.

In an embodiment in which host system A 150 is a primary host system and host system B 152 is a secondary host system. The memory expander card 130 allows the host managed device memory 134 to be shared between the primary host system 150 and the secondary host system 152. The host managed device memory 134 serves as a direct data sharing mechanism between the disparate host systems 150, 152.

The memory address translator 208 directs a received host initiated read request received via the CXL protocol over the PCIe bus 160 to the coherency engine 206 after the memory address received in the read request has been translated to a host managed device memory address for the host managed device memory 134.

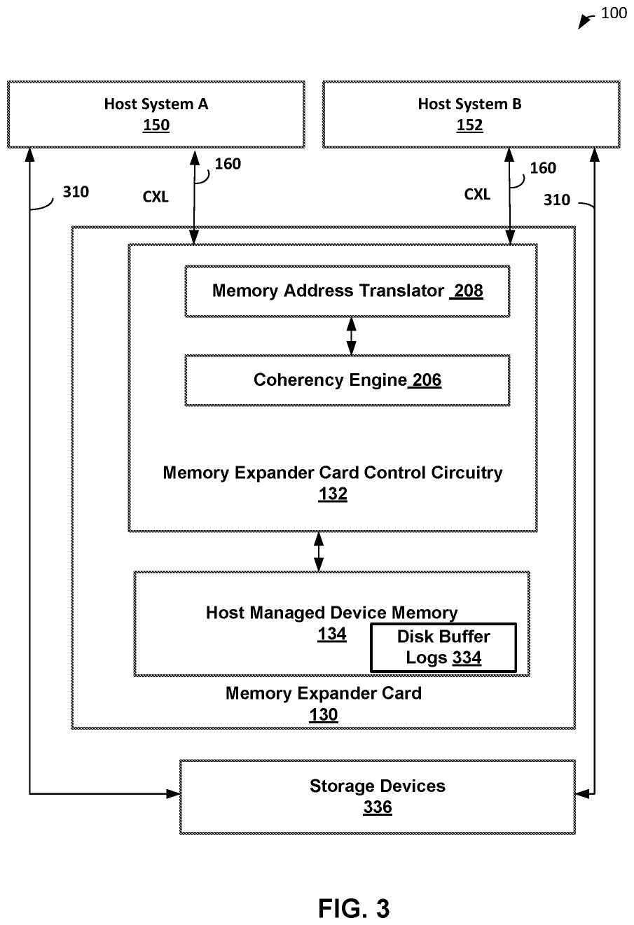

FIG. 3 is a block diagram illustrating coherent memory sharing between the host systems 150, 152 in the host managed device memory 134 in the memory expander card 130 in the high availability system 100 shown in FIG. 1.

The memory expander card 130 includes the memory expander card control circuitry 132 and host managed device memory 134. Host system A 150 and host system B 152 are communicatively coupled to storage devices 336 via a bus 310. Storage devices 336 can store a file system.

Storage devices 336 can include, for example, hard disk drives (“HDD”), solid-state drives (“SSD”), removable storage media, Digital Video Disk (DVD) drive, Compact Disk (CD) drive, Redundant Array of Independent Disks (RAID), tape drive or other storage device. The storage devices can be communicatively and/or physically coupled together through bus 310 using one or more of a variety of protocols including, but not limited to, SAS (Serial Attached SCSI (Small Computer System Interface)), PCIe (Peripheral Component Interconnect Express), NVMe (NVM Express) over PCIe (Peripheral Component Interconnect Express), and SATA (Serial ATA (Advanced Technology Attachment.

The host systems 150, 152 cache data (disk cache blocks) that is stored in storage devices 336 in the host managed device memory 134 via the CXL protocol over the PCIe bus 160. The host systems 150, 152 do not enable CPU level caching for the data stored in storage devices 336 that is cached in the host managed device memory 134. The host managed device memory 134 stores disk buffer logs 334 for the storage devices. The disk buffer logs 334 are operating system (OS) specific and contain pointers to other disk cache blocks stored in the host managed device memory 134.

The pointers to the disk cache blocks stored in the disk buffer logs 334 are specific to a first operating system that runs in host system A 150 and a second operating system that runs in host system B 152. The memory expander card control circuitry 132 to store disk cache blocks in the host managed device memory 134 and to manage the pointers to other disk cache blocks stored in the host managed device memory 134. The memory expander card control circuitry 132 provides a virtual view of the disk cache blocks and pointers to other disk cache blocks to each of the host systems 150, 152.

As the disk cache blocks are stored in the host managed device memory 134 that is shared by the host systems 150, 152, upon failure of one of the host systems 150, 152, the non-failed host system can access memory addresses for the disk cache blocks for the failed host system in response to received read/write requests.

In an embodiment in which the memory expander card control circuitry 132 is a Field Programmable Gate Array (FPGA), the pointers are managed by an Accelerator Functional Unit (AFU). An AFU is a compiled hardware accelerator image implemented in FPGA logic that accelerates an application.

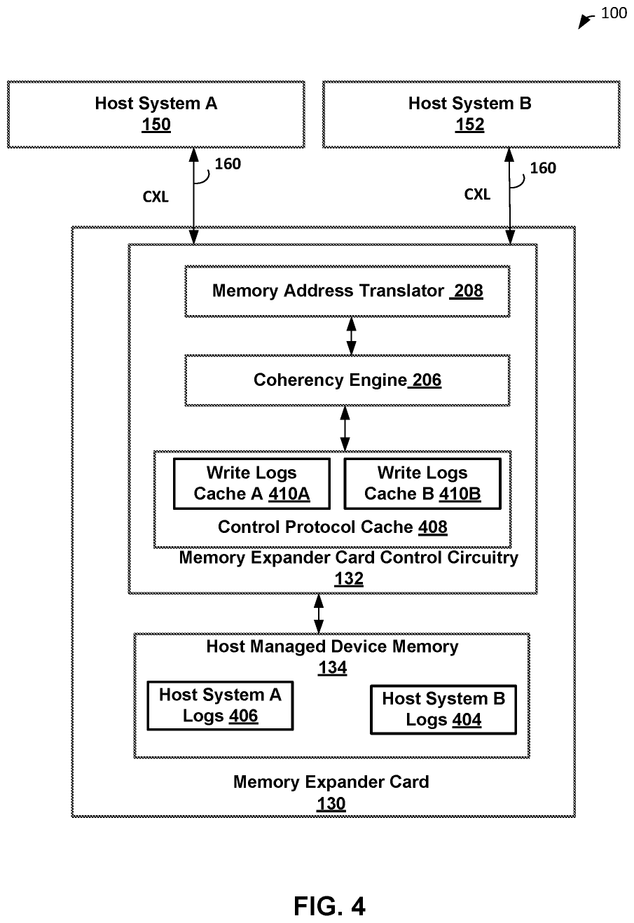

FIG. 4 is a block diagram illustrating sharing of the host device memory in the memory expander card 130 with two host systems 150, 152 independently accessing different areas of the host managed device memory 134 in the high availability system 100 shown in FIG. 1.

Host system A 150 stores write logs in host system A logs 406 in host managed device memory 134 and in write logs cache A 410A in control protocol cache 408. Host system B 152 stores write logs in host system B logs 404 in host managed device memory 134 and in write logs cache B 410B in control protocol cache 408. The Host CPUs do not enable CPU level caching for the memory exported by the CXL device. The write logs are not operating system (OS) specific and can be used by the non-failed host system to take over from the failed host system. The non-failed host system can access the write logs cache A 410A and the write logs cache B 410B in control protocol cache 408, host system A logs 406 and host system B logs 404. Any read/write requests from the non-failed host system can be directly managed from the host system A logs 406 and host system B logs 404 and the non-failed host system can write dirty buffers to storage devices.

The primary host system (for example, Host system A 150) creates logs and stores the logs in the host managed device memory 134 in host system A logs 406 and in write logs cache A 410 in control protocol cache 408. After the primary host system (for example, Host system A 150) fails, the secondary host system (for example, Host System B 152) reads the write logs stored in host system A logs 406 and in write logs cache A 410A in control protocol cache 408 and replays them on the file system to bring the storage devices to the latest consistency point.

In another embodiment, there can be more than two host systems. For example, each host system can be one node in a multi-node cluster. All of the nodes in the multi-node cluster can be connected to the memory expander card 130 and store logs in the host managed device memory 134 in the memory expander card. If a primary node fails, any of the non-failed over nodes can take over as the primary node because all of the other nodes can access the disk buffer logs 334, the write logs cache 410A, 410B, the host system A logs 406, or the host system B logs 404.

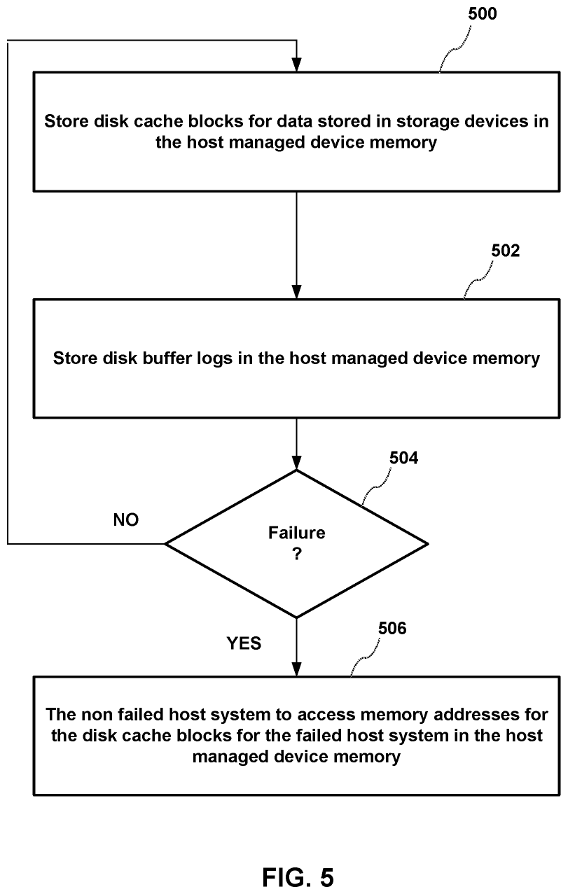

FIG. 5 is a flow graph illustrating a method for performing coherent memory sharing between the host systems 150, 152 in the host managed device memory 134 in the memory expander card 130 shown in FIG. 3.

At block 500, host systems 150, 152 store disk cache blocks for data that is stored in storage devices 336 in the host managed device memory 134 via the CXL protocol over the PCIe bus 160, processing continues with block 502.

At block 502, host systems 150, 152 store disk buffer logs 334 in the host managed memory for the storage devices 336.

At block 504, if one of the host systems 150, 152 fails, processing continues with block 506. If none of the host systems has failed, processing continues with block 500.

At block 506, upon failure of one of the host systems 150, 152, the non-failed host system can access memory addresses for the disk cache blocks for the failed host system in the host managed device memory 134 in response to received read/write requests from the non-failed host system.

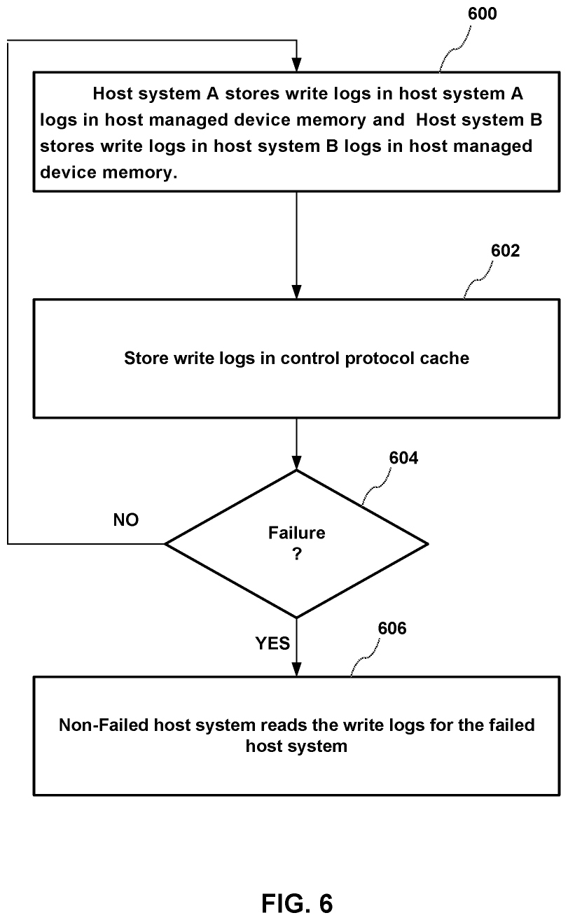

FIG. 6 is a flow graph illustrating a method for sharing of the host device memory in the memory expander card 130 with two host systems 150, 152 independently accessing different areas of the host managed device memory 134 in memory expander card 130 shown in FIG. 4.

At block 600, host system A 150 stores write logs in host system A logs 406 in host managed device memory 134. Host system B 152 stores write logs in host system B logs 404 in host managed device memory 134. Processing continues with block 602.

At block 602, write logs are stored in write logs cache A 410A and write logs cache B 410B in control protocol cache. Processing continues with block 604.

At block 604, if one of the host systems 150, 152 fails, processing continues with block 606. If none of the host systems has failed, processing continues with block 600.

At block 606, the non-failed host system can access the write logs 410 in control protocol cache 408, host system A logs 406 and host system B logs 404.

Flow diagrams as illustrated herein provide examples of sequences of various process actions. The flow diagrams can indicate operations to be executed by a software or firmware routine, as well as physical operations. In one embodiment, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood as an example, and the process can be performed in a different order, and some actions can be performed in parallel. Additionally, one or more actions can be omitted in various embodiments; thus, not all actions are required in every embodiment. Other process flows are possible.

To the extent various operations or functions are described herein, they can be described or defined as software code, instructions, configuration, and/or data. The content can be directly executable (“object” or “executable” form), source code, or difference code (“delta” or “patch” code). The software content of the embodiments described herein can be provided via an article of manufacture with the content stored thereon, or via a method of operating a communication interface to send data via the communication interface. A machine readable storage medium can cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to the disclosed embodiments and implementations of the invention without departing from their scope.

Therefore, the illustrations and examples herein should be construed in an illustrative, and not a restrictive sense. The scope of the invention should be measured solely by reference to the claims that follow.

### EXAMPLES

Illustrative examples of the technologies disclosed herein are provided below. An embodiment of the technologies may include any one or more, and any combination of, the examples described below.

Example 1 is an apparatus comprising a host managed device memory. The host managed device memory is shared between a first host system and a second host system. The apparatus includes control circuitry. The control circuitry to allow direct memory access from the first host system and the second host system to the host managed device memory, to synchronize host initiated write requests to the same memory addresses in the host managed device memory received from the first host system and the second host system to provide memory coherency for the host managed device memory.

Example 2 includes the apparatus of Example 1, optionally the control circuitry to store disk cache blocks in the host managed device memory.

Example 3 includes the apparatus of Example 1, optionally The apparatus of claim 1, wherein the control circuitry to store write logs for the first host system in a first area of the host managed device memory and to store write logs for the second host system in a second area of the host managed device memory, the first area independent from the second area.

Example 4 includes the apparatus of Example 1, optionally the control circuitry is a Field Programmable Gate Array.

Example 5 includes the apparatus of Example 1, optionally upon failure of the first host system, to allow the second host system to access memory addresses in the host managed memory written by the first host system.

Example 6 includes the apparatus of Example 1, optionally the control circuitry to communicate with the first host system and the second host system over a communications bus using a Compute Express Link (CXL).mem protocol over a Peripheral Component Interconnect Express (PCIe) bus.

Example 7 includes the apparatus of Example 1, optionally the control circuitry to communicate with the first host system and the second host system over a communications bus using a Compute Express Link (CXL).cache protocol over a Peripheral Component Interconnect Express (PCIe) bus.

Example 8 is a high availability system comprising a first host system and a second host system. The high availability system includes a memory expander card.

The memory expander card shared between the first host system and the second host system. The memory expander card comprising a host managed device memory. The host managed device memory shared between the first host system and the second host system. The memory expander card comprising control circuitry. The control circuitry to allow direct memory access from the first host system and the second host system to the host managed device memory, to synchronize host initiated write requests to the same memory addresses in the host managed device memory received from the first host system and the second host system to provide memory coherency for the host managed device memory.

Example 9 includes the high availability system of Example 8, optionally the control circuitry to store disk cache blocks in the host managed device memory.

Example 10 includes the high availability system of Example 8, optionally the control circuitry to store write logs for the first host system in a first area of the host managed device memory and to store write logs for the second host system in a second area of the host managed device memory, the first area independent from the second area.

Example 11 includes the high availability system of Example 8, optionally the control circuitry is a Field Programmable Gate Array.

Example 12 includes the high availability system of Example 8, optionally upon failure of the first host system, to allow the second host system to access memory addresses in the host managed memory written by the first host system.

Example 13 includes the high availability system of Example 8, optionally the control circuitry to communicate with the first host system and the second host system over a communications bus using a Compute Express Link (CXL).mem protocol over a Peripheral Component Interconnect Express (PCIe) bus.

Example 14 includes the high availability system of Example 8, optionally the control circuitry to communicate with the first host system and the second host system over a communications bus using a Compute Express Link (CXL).cache protocol over a Peripheral Component Interconnect Express (PCIe) bus.

Example 15 is a method including a host managed device memory between a first host system and a second host system, a host managed device memory. The method allowing, by control circuitry, direct memory access from the first host system and the second host system to the host managed device memory, to synchronize host initiated write requests to the same memory addresses in the host managed device memory received from the first host system and the second host system to provide memory coherency for the host managed device memory.

Example 16 includes the method of Example 15, optionally storing disk cache blocks in the host managed device memory.

Example 17 includes the method of Example 15, optionally storing logs for the first host system in a first area of the host managed device memory and storing logs for the second host system in a second area of the host managed device memory, the first area independent from the second area.

Example 18 includes the method of Example 15, optionally the control circuitry is a Field Programmable Gate Array.

Example 19 includes the method of Example 15, optionally allow accessing, by the second host system, upon failure of the first host system, memory addresses in the host managed memory written by the first host system.

Example 20 includes the method of Example 15, optionally communicating, by the control circuitry, with the first host system and the second host system over a communications bus using a Compute Express Link (CXL).mem protocol over a Peripheral Component Interconnect Express (PCIe) bus.

Example 21 includes the method of Example 15, optionally communicating, by the control circuitry, with the first host system and the second host system over a communications bus using a Compute Express Link (CXL).cache protocol over a Peripheral Component Interconnect Express (PCIe) bus.

Example 22 is an apparatus comprising means for performing the methods of any one of the Examples 15 to 21.

Example 23 is a machine readable medium including code, when executed, to cause a machine to perform the method of any one of claims 15 to 21.

Example 22 is a machine-readable storage including machine-readable instructions, when executed, to implement the method of any one of claims 15 to 2.

What is claimed is:

1. An apparatus comprising:
a host managed device memory, the host managed device memory shared between a first host system and a second host system; and
control circuitry, the control circuitry to allow direct memory access from the first host system and the second host system to the host managed device memory, to synchronize host initiated write requests to the same memory addresses in the host managed device memory received from the first host system and the second host system to provide memory coherency for the host managed device memory.

2. The apparatus of claim 1, wherein the control circuitry to store disk cache blocks in the host managed device memory.

3. The apparatus of claim 1, wherein the control circuitry to store write logs for the first host system in a first area of the host managed device memory and to store write logs for the second host system in a second area of the host managed device memory, the first area independent from the second area.

4. The apparatus of claim 1, wherein the control circuitry is a Field Programmable Gate Array.

5. The apparatus of claim 1, wherein upon failure of the first host system, to allow the second host system to access memory addresses in the host managed memory written by the first host system.

6. The apparatus of claim 1, wherein the control circuitry to communicate with the first host system and the second host system over a communications bus using a Compute Express Link (CXL).mem protocol over a Peripheral Component Interconnect Express (PCIe) bus.

7. The apparatus of claim 1, wherein the control circuitry to communicate with the first host system and the second host system over a communications bus using a Compute Express Link (CXL).cache protocol over a Peripheral Component Interconnect Express (PCIe) bus.

8. A high availability system comprising:
a first host system;
a second host system;
a memory expander card, the memory expander card shared between the first host system and the second host system, the memory expander card comprising:
a host managed device memory, the host managed device memory shared between the first host system and the second host system; and
control circuitry, the control circuitry to allow direct memory access from the first host system and the second host system to the host managed device memory, to synchronize host initiated write requests to the same memory addresses in the host managed device memory received from the first host system and the second host system to provide memory coherency for the host managed device memory.

9. The high availability system of claim 8, wherein the control circuitry to store disk cache blocks in the host managed device memory.

10. The high availability system of claim 8, wherein the control circuitry to store write logs for the first host system in a first area of the host managed device memory and to store write logs for the second host system in a second area of the host managed device memory, the first area independent from the second area.

11. The high availability system of claim 8, wherein the control circuitry is a Field Programmable Gate Array.

12. The high availability system of claim 8, wherein upon failure of the first host system, to allow the second host system to access memory addresses in the host managed memory written by the first host system.

13. The high availability system of claim 8, wherein the control circuitry to communicate with the first host system and the second host system over a communications bus using a Compute Express Link (CXL).mem protocol over a Peripheral Component Interconnect Express (PCIe) bus.

14. The high availability system of claim 8, wherein the control circuitry to communicate with the first host system and the second host system over a communications bus using a Compute Express Link (CXL).cache protocol over a Peripheral Component Interconnect Express (PCIe) bus.

15. A method comprising:
sharing, between a first host system and a second host system, a host managed device memory; and
allowing, by control circuitry, direct memory access from the first host system and the second host system to the host managed device memory, to synchronize host initiated write requests to the same memory addresses in the host managed device memory received from the first host system and the second host system to provide memory coherency for the host managed device memory.

16. The method of claim 15, further comprising:
storing disk cache blocks in the host managed device memory.

17. The method of claim 15, further comprising:
storing logs for the first host system in a first area of the host managed device memory; and
storing logs for the second host system in a second area of the host managed device memory, the first area independent from the second area.

18. The method of claim 15, wherein the control circuitry is a Field Programmable Gate Array.

19. The method of claim 15, to allow accessing, by the second host system, upon failure of the first host system, memory addresses in the host managed memory written by the first host system.

20. The method of claim 15, further comprising:
communicating, by the control circuitry, with the first host system and the second host system over a communications bus using a Compute Express Link (CXL).mem protocol over a Peripheral Component Interconnect Express (PCIe) bus.

21. The method of claim 15, further comprising:
communicating, by the control circuitry, with the first host system and the second host system over a communications bus using a Compute Express Link (CXL).cache protocol over a Peripheral Component Interconnect Express (PCIe) bus.
